(19) United States
(12) Patent Application Publication
(10) Pub. No.: US 2026/0194191 A1
(43) Pub. Date: Jul. 9, 2026

(54) TANK SYSTEM FOR A HYDROGEN POWERED VEHICLE, FUEL CELL ASSEMBLY, HYDROGEN INTERNAL COMBUSTION ENGINE SYSTEM, FUEL CELL POWERED VEHICLE, HYDROGEN POWERED VEHICLE

(71) Applicant: Robert Bosch GmbH, Stuttgart (DE)

(72) Inventor: Adeline Tchikango Siagam, Stuttgart (DE)

(21) Appl. No.: 19/129,756

(22) PCT Filed: Oct. 19, 2023
(86) PCT No.: PCT/EP2023/079096

§ 371 Date: May 14, 2025

(30) Foreign Application Priority Data
Nov. 15, 2022 (DE) 10 2022 212 108.2

(51) Int. Cl. F17C 13/04; H01M 8/04082

(52) U.S. Cl. CPC F17C 13/04; H01M 8/04201; F17C 2201/0109; F17C 2205/0323; F17C 2221/012; F17C 2223/0123; F17C 2265/066; F17C 2270/0168; F17C 2270/0184; H01M 2250/20

(57) ABSTRACT

The invention relates to a tank system (100) for a hydrogen powered vehicle, wherein the tank system (100) comprises at least one cylindrical tank container (200) for storing a gaseous medium, in particular hydrogen, and a valve device (4). The at least one tank container (200) and the valve device (4) are operatively connected and fluidly connected to one another. The at least one tank container (200) has a tank container interior (2), wherein the valve device (4) has a flow device (6), which flow device (6) is at least partly arranged within the tank container interior (2) and by means of which flow device (6) the tank container interior (2) can be filled with a gaseous medium, in particular hydrogen. The flow device (6) additionally has a bypass (12) with a first branch (8) and a second branch (9), said first branch (8) being arranged coaxially to a longitudinal axis (14) of the tank container (200) and said second branch (9) having a longitudinal axis (140) which longitudinal axis (140) is arranged in an angular range a between 15 degrees and 60 degrees relative to the longitudinal axis (14) of the tank container (200), wherein deflecting elements (5) are arranged in the tank container interior (2), by means of which deflecting elements (5) the flow of the gaseous medium, in particular hydrogen, can be deflected.

### BACKGROUND

The present invention relates to a tank system for a hydrogen powered vehicle. Further, the tank system is applicable in a fuel cell assembly or in a hydrogen internal combustion engine system. The invention further relates to a fuel cell drive vehicle and a hydrogen powered vehicle.

DE 10 2017 212 485 A1 describes a device for storing compressed fluids that serve as fuel for a vehicle, wherein the device comprises at least two tubular tank containers and at least one high-pressure fuel distributor having at least one integrated control and safety system.

Fueling of such storage devices is carried out under clearly defined boundary conditions. The aim of these boundary conditions is to prevent temperature increases from occurring that could either affect the safety of the storage device or would cause too low fill levels at the end of the fueling. These boundary conditions have been developed for carbon fiber-reinforced storage devices with low L/D ratios.

The L/D ratio here is a ratio between the length L and the diameter D of a cylindrical storage device. From an L/D ratio of 3, and above a L/D ratio of 6, the mixing by the turbulent medium jet is significantly weakened, and the heat transfer by forced convection is superposed by the natural convection. In addition, the beam loses energy in the rear region of the storage device, and the natural convection is not sufficient to ensure a good mixing. Furthermore, the gas jet is compressed in the rear region of the storage device and thereby heated. That is to say, the gas jet in the front region of the storage device is cooler than in the rear region of the storage device.

### SUMMARY

By contrast, the device according to the invention having the characterizing features of the disclosure has the advantage that an optimal mixing of the gaseous medium, in particular hydrogen, in the tank system, is achieved, even in tank systems with a high L/D ratio.

To this end, the tank system for a hydrogen powered vehicle comprises at least one cylindrical tank container for storing a gaseous medium, in particular hydrogen, and a valve device. The at least one tank container and the valve device are operatively connected and are fluidly connected to one another. The at least one tank container comprises a tank container interior, and the valve device has a flow device, which flow device is at least partly arranged within the tank container interior and by means of which flow device the tank container interior can be filled with a gaseous medium, in particular hydrogen. Moreover, the flow device additionally has a bypass with a first branch and a second branch, said first branch being arranged coaxially to a longitudinal axis of the tank container and said second branch having a longitudinal axis which longitudinal axis is arranged in an angular range a between 15 degrees and 60 degrees relative to the longitudinal axis of the tank container. Deflecting elements are arranged in the tank container interior, by means of which deflecting elements the flow of the gaseous medium, in particular hydrogen, can be deflected.

Thus, an increase in the turbulence within the tank container and an optimized mixing of the gaseous medium, in particular hydrogen, can be achieved in a simple manner.

In the first advantageous further development, it is provided that the deflecting elements are arranged on an inner tank wall of the tank container interior. Advantageously, the deflecting elements are arranged in helical arrangement in the tank container. Advantageously, the deflecting elements comprise a first deflecting element, a last deflecting element, and further deflecting elements.

In a further embodiment of the invention, it is advantageously provided that the first deflecting element is arranged on the inner tank wall of the tank container interior such that, upon entry of a second flow jet of gaseous medium, in particular hydrogen, it can be directed onto the first deflecting element via the second branch of the bypass into the tank container interior, wherein the first deflecting element is configured such that the first deflecting element directs the second flow jet onto the further deflecting elements up to the last deflecting element.

The constructive orientation of the deflecting elements in the tank container is designed so that a strengthening of the pulse energy of the flow of the gaseous medium, in particular hydrogen, is favored and a good mixing is achieved within the tank container.

The tank system described herein is preferably suited for use in a fuel cell assembly for storing hydrogen for operating a fuel cell.

The tank system described is preferably suitable in a hydrogen internal combustion engine system.

In advantageous uses, the tank device can be used in vehicles with a fuel cell drive.

In advantageous uses, the tank device can be used in vehicles with a hydrogen drive.

### BRIEF DESCRIPTION OF THE DRAWINGS

The invention is described in greater detail below with reference to the drawing.

Shown are:

FIG. 1a a schematic plan view of a tank system according to the invention,

FIG. 1b a schematic plan view of a tank system according to the invention, having a first flow jet and a second flow jet of gaseous medium,

FIG. 2 a sectional view of the tank system of FIG. 1a,

FIG. 3 a hydrogen powered vehicle having a fuel cell assembly or a hydrogen internal combustion engine system having a tank system according to the present invention in a simplified schematic view.

All of the drawings are merely schematic representations of the tank system according to the invention or its components according to exemplary embodiments of the invention. In particular, distances and size relations are not reproduced to scale in the drawings.

### DETAILED DESCRIPTION

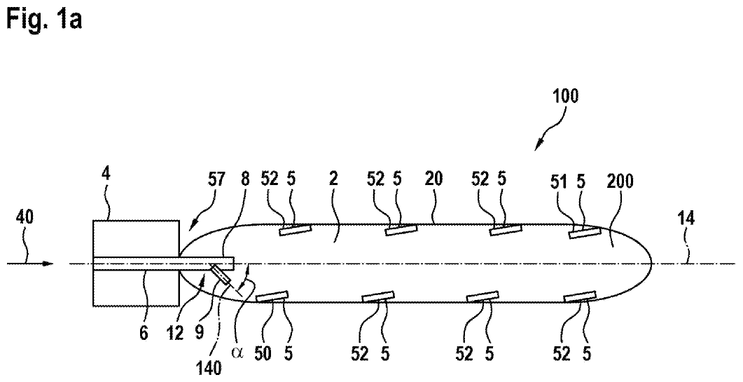

FIG. 1a shows a schematic plan view of a tank system 100 according to the invention for a hydrogen powered vehicle. In this exemplary embodiment, the tank system 100 comprises a cylindrical tank container 200 having a longitudinal axis 14 for storing hydrogen. In an alternative embodiment, the tank system 100 can have a plurality of tank containers 200 which can be fluidly connected via a connecting line.

Furthermore, the tank container 200 comprises a valve assembly 4 operatively associated with the tank container 200 and fluidly connected thereto. The valve assembly 4 is integrated in an end region 57 of the tank container 200, for example via a screw connection, and projects partly into a tank container interior 2 of the tank container 200.

The tank system 100 further comprises a flow device 6, which is fixedly connected to the valve assembly 4 and by means of which the tank container interior 2 can be filled with gaseous medium, in particular hydrogen. The flow device 6 comprises a bypass 12 having a first branch 8 and a second branch 9. The first branch 8 is arranged coaxially to the longitudinal axis 14 of the tank container 200, whereas the second branch 9 has a longitudinal axis 140 which is arranged at an angular range a between 15 degrees and 60 degrees relative to the longitudinal axis 14 of the tank container 200.

Furthermore, deflecting elements 5 are arranged in the tank container interior 2 by means of which the flow of the gaseous medium, in particular hydrogen, can be deflected. The deflecting elements 5 are arranged and fixed on an inner tank wall 20 of the tank container 200. Furthermore, the deflecting elements 5 comprise a first deflecting element 50, a last deflecting element 51, and further deflecting elements 52.

When filling the tank container interior 2 with gaseous medium, in particular hydrogen, the tank container 200 is filled with gaseous medium via the flow device 6, as shown in FIG. 1b. Having arrived at the bypass 12, the flow of the gaseous medium divides into a first flow jet 55 via the first branch 8 and a second flow jet 56 via the second branch 9. The first flow jet 55 from the first branch 8 is guided centrally and is released in the tank container interior 2 without further deflection. The second flow jet 56 from the second branch 9 is released in the tank container interior 2 at an angular range a between 15 degrees and 60 degrees relative to the longitudinal axis 14 of the tank container 200 and oriented such that it is directed towards and strikes the first deflecting element 50. Thus, the second flow jet 56 receives a new pulse, and this pulse is guided to the next further deflecting element 52 until the last deflecting element 51 is reached. As a result, the second flow jet 56 from the second branch 9 is crossed multiple times with the first flow jet 55 from the first branch 8, resulting in an optimal mixing of the gaseous medium, in particular hydrogen, in the tank container 200, for example also in a tank bottom region 58. This procedure is repeated until the second flow jet 56 is directed out of the second branch 9 with the necessary pulse energy up to the last deflecting element 51.

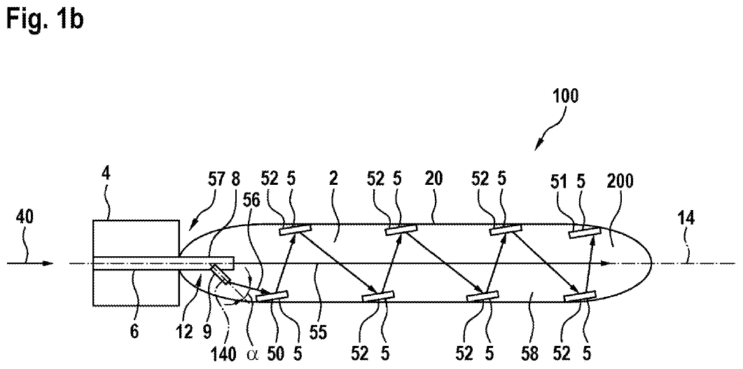

FIG. 2 shows a cross-sectional view of the tank system 100, in particular the tank container 200, and again illustrates the arrangement and design of the deflecting elements 5 on the inner tank wall 20 of the tank container 200. Here, the deflecting elements 5 are arranged in a helical arrangement in the cylindrical tank container 200.

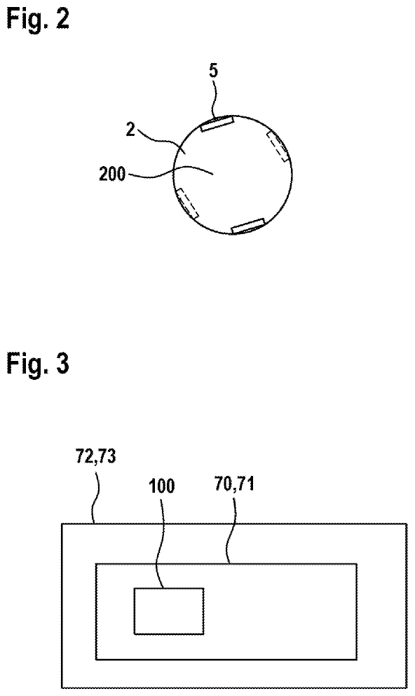

FIG. 3 illustrates, in a simplified schematic view, a hydrogen powered vehicle 72 that can operate with, for example, a fuel cell assembly 70 as a fuel cell powered vehicle 73, or a hydrogen internal combustion engine system 71. The fuel cell assembly 70 or the hydrogen internal combustion engine system 71 comprises the tank system 100 according to the invention for providing hydrogen.

1. A tank system (100) for a hydrogen powered vehicle, wherein the tank system (100) comprises at least one cylindrical tank container (200) for storing a gaseous medium and a valve device (4), wherein the at least one tank container (200) and the valve device (4) are operatively connected and fluidly connected to one another, wherein the at least one tank container (200) has a tank container interior (2), wherein the valve device (4) has a flow device (6), which flow device (6) is at least partly arranged within the tank container interior (2) such that the tank container interior (2) can be filled with a gaseous medium, wherein the flow device (6) has a bypass (12) with a first branch (8) and a second branch (9), said first branch (8) being arranged coaxially to a longitudinal axis (14) of the tank container (200) and said second branch (9) having a longitudinal axis (140) arranged in an angular range a between 15 degrees and 60 degrees relative to the longitudinal axis (14) of the tank container (200), wherein deflecting elements (5) are arranged in the tank container interior (2) such that a flow of the gaseous medium can be deflected.

2. The tank system (100) according to claim 1, wherein the deflecting elements (5) are arranged on an inner tank wall (20) of the tank container interior (2).

3. The tank system (100) according to claim 2, wherein the deflecting elements (5) are arranged in a helical arrangement in the tank container (200).

4. The tank system (100) according to claim 2, wherein the deflecting elements (5) comprise a first deflecting element (50), a last deflecting element (51) and further deflecting elements (52).

5. The tank system (100) according to claim 4, wherein the first deflecting element (50) is arranged on the inner tank wall (20) of the tank container interior (2), such that, upon entry of a second flow jet (56) of gaseous medium, the second flow jet (56) can be directed onto the first deflecting element (50) via the second branch (9) of the bypass (12) into the tank container interior (20), wherein the first deflecting element (50) is configured such that the first deflecting element (50) directs the second flow jet (56) onto the further deflecting elements (52) up to the last deflecting element (51).

6. A fuel cell assembly (70) having a tank system (100) for storing hydrogen for operating a fuel cell according to claim 1.

7. A hydrogen internal combustion engine system (71) having a tank system (100) for storing hydrogen according to claim 1.

8. A fuel cell powered vehicle (73) having a tank system (100) for storing hydrogen according to claim 1.

9. A hydrogen powered vehicle (72) having a tank system (100) for storing hydrogen according to claim 1.

10. The tank system (100) according to claim 1, wherein the gaseous medium is hydrogen.
